(19) United States
(12) Patent Application Publication
(10) Pub. No.: US 2009/0244285 A1
(43) Pub. Date: Oct. 1, 2009

(54) SYSTEM AND METHOD FOR PROVIDING CREATION OF ON-SIDE TEXT FOR VIDEO SURVEILLANCE

(75) Inventors: Silky Chathukutty, Bangalore (IN); Vijay Dhamija, Banglore (IN); Marine Drive, Bangalore (IN); Andrew Jackson, Las Vegas, NV (US); Jeetendra Kumar Mallireddy, Bangalore (IN); Phillip Mcinnes, Richardson, TX (US); Arun Pattali, Bangalore (IN); Sandeep Pundlik, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/060,657

(22) Filed: Apr. 1, 2008

(51) Int. Cl. H04N 7/18

(52) U.S. Cl. 348/150; 348/E07.085

(57) ABSTRACT

A system and method for generating side-by-side video surveillance feed and point-of-service device text is provided. The system includes a video surveillance device, a point-of-service device such as an ATM, slot machine and point-of-sale device, and a synchronizing unit for synchronizing the video surveillance feed with point-of-service text when a security officer identifies activities matching a predetermined criteria occurring at the point-of-service device. The video surveillance feed is generated and processed for display on a security monitor. When an activities matching the predetermined criteria is identified near a point-of-service device, point-of-service text is received from the device. Both the video surveillance feed and the point-of-service text are displayed side-by-side so that neither data obscures the other. The video surveillance feed and the point-of-service text are also synchronized to one another and stored for later use.

### FIELD OF THE INVENTION

The present invention relates generally to video surveillance and more specifically to a system and method for providing on-side text for video surveillance.

### BACKGROUND OF THE DISCLOSURE

Video surveillance is used to monitor areas in an unobtrusive manner. By using video cameras, security personnel can monitor a plurality of locations for suspicious activities. This is especially true at locations such as point-of-sale, near automated teller machines (ATM), slot machines, casino gaming tables, etc., collectively referred to hereinafter as point-of-service (POS) devices.

Often, fraudulent transactions are difficult to determine based either on a video clip or transaction log alone. However, by combining multiple information sources regarding a particular transaction, fraud or theft can be more readily discovered.

For example a voided sale transaction by itself does not suggest fraud by an employee of a store, as it might be a legitimate transaction in which the employee returns the void commodity back to inventory. However, when the voided transaction is aligned with video data of the scene, a theft of merchandise may become evident depending on whether the employee returns the voided merchandise back in inventory or not. Without the voided transaction, it would be both time consuming and, often times, difficult to find evidence of theft while reviewing video backups, because there would not be any reference point from which security personnel can use when reviewing the video backups.

In conventional video surveillance, suspicious activities observed on a video surveillance monitor are recorded as video clips onto a video recording device for further analysis at a later time. The video clips include a portion of the video feed containing the suspicious activity and a text overlay. The text overlay generally contains data from the POS devices.

However, while the text overlay may provide useful information regarding the suspicious activity to subsequent analysts and investigators, one drawback to the conventional video surveillance is that the text overlay obscures portions of the video.

### SUMMARY OF THE DISCLOSURE

An embodiment of the present invention for generating side-by-side video and text includes a video surveillance unit for generating and processing video surveillance feed; a text input unit for requesting point-of-service (POS) text from a POS device when a predetermined criteria is detected; a POS controller for receiving the requested POS text; a display unit for displaying the video surveillance feed and the POS text side-by-side; and a synchronizing unit for synchronizing the video surveillance feed and the POS text.

Another embodiment of the present invention for generating side-by-side video and text for video surveillance includes a computer readable medium containing instructions executable by a computer for performing the steps of generating and processing video surveillance data; requesting point-of-service (POS) text from a POS device when a predetermined criteria is detected; receiving the requested POS text; displaying both the video surveillance feed and the POS text side-by-side; and synchronizing the video surveillance feed and the POS text.

Another embodiment of the present invention for generating side-by-side video and text for video surveillance is a process including the steps of generating and processing video surveillance data; requesting point-of-service (POS) text from a POS device when a predetermined criteria is detected; receiving the requested POS text; displaying both the video surveillance feed and the POS text side-by-side; and synchronizing the video surveillance feed and the POS text.

### BRIEF DESCRIPTION OF THE DRAWINGS

These and other features, aspects, and advantages of the present invention will become better understood with regard to the following description, appended claims, and accompanying drawings wherein:

FIG. 1 illustrates a block representation of an embodiment of the present invention; and

FIG. 2 illustrates a flow diagram of the process for performing an embodiment of the present invention.

### DETAILED DESCRIPTION OF DISCLOSURE

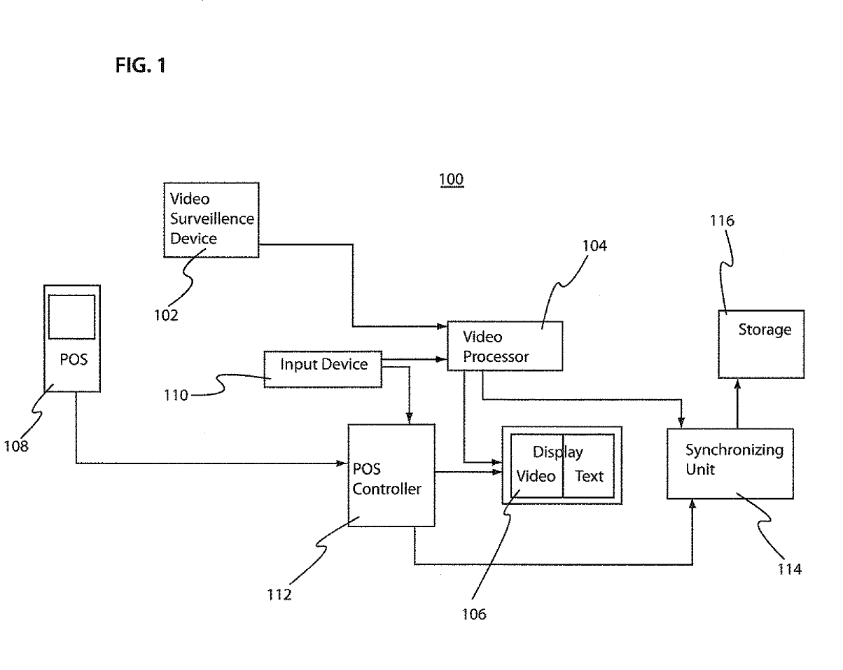

Referring to FIG. 1, an embodiment of a system for providing side-by-side text and video is shown. A video signal generated by a video surveillance device 102 is transmitted to a video processor 104 where the video signal is formatted for display on a display 106. During viewing of the video signal on the display 106, a security officer can selectively view data from a POS device 108 being monitored along side portions of video showing activity matching a predetermined criteria using a user input device 110.

Once the user input device 110 is actuated by the security officer, the POS text from the POS device 108 is transmitted to a POS controller 112. The POS controller 112 converts the POS text from the POS device 108 into an image display signal and transmits the signal to the display 106.

In addition to displaying the video signal and POS text on the display 106, the present embodiment also stores the video signal and POS text in a synchronized manner on a medium readable by a computer and/or video playback device when the user input device is actuated. The video processor 104 and POS controller 112 transmit the respective signals to a synchronizing device 114. Where, the video and POS text are synchronized. Synchronization may be accomplished by attaching a matching timestamp to both the video and POS text, or attaching a frame reference id to the POS text that refers to a position on the video that corresponds to the time interval in which the POS text was generated.

Alternatively, the synchronizing device 114 combines the video and POS text such that the POS text is synchronized with the video at the time that the POS text was generated. The combined data is then transferred to storage 116 and stored as one data file.

By synchronizing the POS text and video in this way, a security officer can review both the status and behavior of the POS device 108, and the activities occurring in proximity to the POS device 108 as recorded by the video surveillance device 102. The information so provided will allow a security officer to identify activities, which may represent tampering with or fraudulent use of the POS device 108.

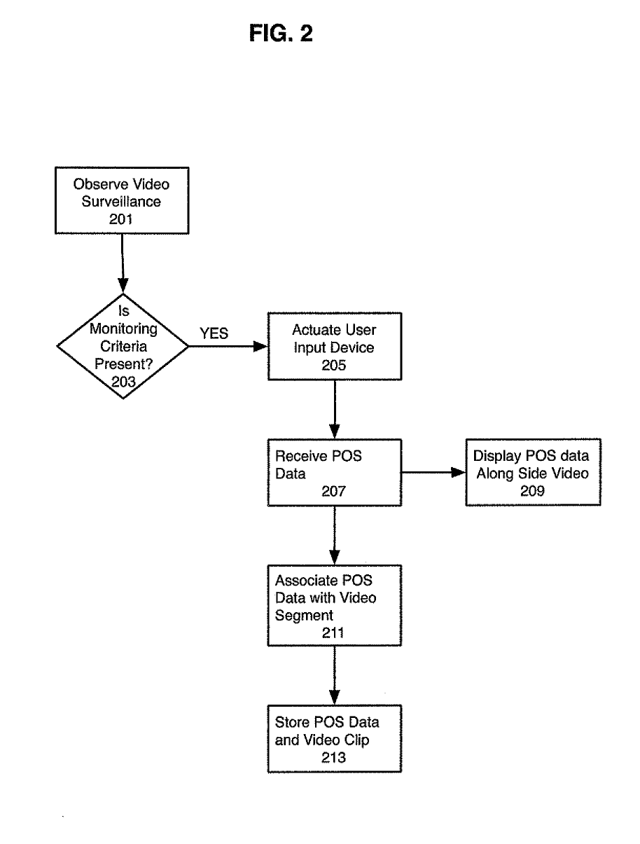

Referring to FIG. 2, the steps for performing an embodiment of the present invention are shown. Beginning with step 201, a security officer observes video surveillance feeds from one or more video cameras in real time. During viewing of the video surveillance feed, the security officer determines in step 203 if activity matching a predetermined criteria is present that might be indicative of tampering, fraud or theft.

However, if the security officer determines, in step 203, that an activity matching a predetermined criteria is occurring, the security officer requests POS text from the POS device by actuating a user input device, such as a control key, menu option, etc. in step 205. A POS controller in step 207 receives POS text from the POS device. In step 209, the POS text is displayed along side the video surveillance feed.

In addition, the POS text and video surveillance feed segment corresponding to the time interval in which the POS text was generated are synchronized in step 211. One method of synchronization may take the form of embedding matching timestamps in both the video surveillance feed segment and the POS text. The synchronized POS text and video surveillance feed segment are stored in step 213.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A video surveillance system for generating side-by-side video and text, said system comprising:
a video surveillance unit for generating and processing video surveillance feed;
a text input unit for requesting point-of-service (POS) text from a POS device when a predetermined criteria is detected;
a POS controller for receiving said requested POS text;
a display unit for displaying said video surveillance feed and said POS text side-by-side; and
a synchronizing unit for synchronizing said video surveillance feed and said POS text.

2. The system as in claim 1, further comprising a storage unit for storing said video surveillance feed and said POS text.

3. The system as in claim 2, wherein said storage is a recording medium readable by a video playback system.

4. The system as in claim 2, wherein said storage is a computer-readable medium.

5. The system as in claim 1, wherein said synchronizing unit embeds a timestamp into said said POS text corresponding to a timestamp in said video surveillance feed.

6. The system as in claim 1, wherein said synchronizing unit embeds a video frame reference id into said POS text corresponding to a video frame of said video surveillance feed.

7. A method for generating side-by-side video and text for video surveillance, said method comprising:
generating and processing video surveillance data;
requesting point-of-service (POS) text from a POS device when a predetermined criteria is detected;
receiving said requested POS text;
displaying both said video surveillance feed and said POS text side-by-side; and
synchronizing said video surveillance feed and said POS text.

8. The method as in claim 7, further comprising storing said video surveillance feed and said POS text.

9. The method as in claim 8, wherein said video surveillance feed and said POS text is stored on a recording medium readable by a video playback system.

10. The system as in claim 8, wherein said video surveillance feed and said POS text is stored on a computer-readable medium.

11. The method as in claim 7, wherein said synchronizing step embeds a timestamp into said said POS text corresponding to a timestamp in said video surveillance feed.

12. The method as in claim 7, wherein said synchronizing step embeds a video frame reference id into said POS text corresponding to a video frame of said video surveillance feed.

13. A computer readable medium embodying instructions executable by a processor for performing a method for generating side-by-side video and text for video surveillance, said method comprising:
generating and processing video surveillance data;
requesting point-of-service (POS) text from a POS device when a predetermined criteria is detected;
receiving said requested POS text;
displaying both said video surveillance feed and said POS text side-by-side; and
synchronizing said video surveillance feed and said POS text.

14. The method as in claim 13, further comprising storing said video surveillance feed and said POS text.

15. The method as in claim 14, wherein said video surveillance feed and said POS text is stored on a recording medium readable by a video playback system.

16. The method as in claim 13, wherein said synchronizing step embeds a timestamp into said said POS text corresponding to a timestamp in said video surveillance feed.

17. The method as in claim 13, wherein said synchronizing step embeds a video frame reference id into said POS text corresponding to a video frame of said video surveillance feed.
